(19) United States
(12) Patent Application Publication
(10) Pub. No.: US 2002/0091698 A1
(43) Pub. Date: Jul. 11, 2002

(54) System and method for accessing and presenting representative appointment information

(76) Inventors: Freeland Glen Young III, Glen Allen, VA (US); Pamela Callis Totty, Richmond, VA (US)

Correspondence Address: Hunton & Williams, 1900 K Street, N.W., Washington, DC, 20006-1109, US

(21) Appl. No.: 09/738,994

(22) Filed: Dec. 19, 2000

(51) Int. Cl. G06F 7/00; G06F 17/30

(52) U.S. Cl. 707/10

(57) ABSTRACT

The present invention relates generally to systems, methods and software applications for storing, retrieving, and displaying information. More particularly, the present invention relates to providing a comprehensive, interactive tool for storing, retrieving, and displaying financial representative appointment information. The method of the present invention comprises the steps of receiving appointment information; analyzing and sorting the received appointment information; saving the received appointment information; providing an interactive display of the received appointment information; and allowing access to the displayed received appointment information.

### BACKGROUND OF THE INVENTION

The present invention relates generally to a system, method and software application for storing, retrieving, and displaying information. More particularly, the present invention relates to a system, method and software application which allow for the interactive storage, retrieval, and display of appointment information for financial representatives and insurance companies. The present invention allows users to more easily and conveniently access representative appointment information and update representative contact information.

Insurance companies generally offer a wide variety of insurance and financial plans suited for various types of individuals and circumstances. To offer and manage these plans, insurance companies generally rely on great numbers of financial representatives and insurance agents (hereafter collectively referred to as “representatives”) to sell and issue insurance policies to individual policy holders on their behalf. Each insurance company authorizes its representatives to write policies on its behalf by way of an appointment.

Generally, an appointment is a legal authorization which allows a representative to act on behalf of an appointing insurance company and to enter into specific agreements with policy holders on its behalf. Generally, each representative is appointed for a given time, within a given state, with the authority to sell a particular set of products. To assist in tracking each of their financial representatives, appointing companies generally assign a writing code or other identifying number to each representative. Commonly, a single appointed representative can be responsible for creating millions of dollars in financial obligations for an appointing insurance company. Accordingly, it is very important for both insurance companies and their representatives to be able to accurately track and manage appointment information.

Presently, insurance companies track representatives and their appointment status by maintaining and updating a set of paper files with the support of a computerized database system. Generally, direct access to information on this system is limited to appointment administrators directly responsible for updating and maintaining these records. When updates are required, generally the responsible appointment administrators make all of the necessary changes manually and then generate a letter or a phone call to the affected representative confirming the change. When the representative wishes to make a change, the representative is responsible for calling or writing the insurance company to effect the change and the company, through its appointment administrators, then updates its files accordingly.

As may be apparent, the present system for tracking appointment information has several drawbacks which makes it inadequate to manage large numbers of representatives. First, the present system requires large numbers of people to oversee and manage the files and information for each representative. This makes the present system very expensive and burdensome on appointing companies. Secondly, even when the present system is properly staffed and maintained, the system still requires frequent contact between the insurance company and its representatives. Thirdly, even with frequent contact, the present system relies heavily on the representatives themselves to keep track of their appointment information and to provide updates as necessary. This results in the present system being very prone to human error and communication breakdowns.

Accordingly, there is a strong need in the insurance industry for a system which reduces the time and effort required by insurance companies and their representatives to manage appointment information. Additionally, there is a strong need for a system which allows individual representatives to easily access their appointment information and to update their own contact information.

### BRIEF SUMMARY OF THE INVENTION

The present invention overcomes the problems noted above and provides additional advantages, by providing a system, method and software application which enables users to interactively store, retrieve, and display appointment information.

According to the present invention, appointment information is able to be accessed and displayed so that remote users can manage and track their own appointment information. Additionally, prospective representatives may access and display the status of their prospective appointments in real time. Further, representatives may update their personal information electronically without having to directly contact their appointing insurance company.

Additionally, the present invention also provides various other options to users such as: access to appointment forms; date range search capabilities; and various printing and reporting options. By providing the above described features in a comprehensive, user friendly manner, the present invention optimizes the efficiency of the entire appointment information process.

Additional advantages of the present invention will be set forth in part in the description which follows, and in part will be obvious from the description, or may be learned by practice of the invention. The advantages of the invention may be realized and attained by means of instrumentalities and combinations, particularly pointed out in the appended claims.

To achieve the advantages and in accordance with the purpose of the invention, as embodied and broadly described herein, in its broadest aspects, the present invention relates to a method for enabling interactive access to and verification of representative appointment information. The method comprises the steps of: providing one or more instructions for the receiving representative appointment information; providing one or more instructions for analyzing and sorting the received representative appointment information; providing one or more instructions for saving the received representative appointment information; providing one or more instructions for presenting an interactive display of the received representative appointment information; and providing an interactive means to allow access to the displayed and presented received representative appointment information.

In another aspect, the invention comprises a computer readable medium including a software application for enabling interactive access to representative appointment information. The software application comprises one or more instructions for receiving the representative appointment information; one or more instructions for analyzing and sorting the received representative appointment information; one or more instructions for saving the received representative appointment information; one or more instructions for presenting an interactive display of the received representative appointment information; and an interface means for allowing interactive access to the displayed and presented received representative appointment information.

In yet another aspect, the present invention comprises a server system for providing access to representative appointment information, wherein the system comprises an inputting element for inputting received representative appointment information; a processing element for analyzing and sorting the received representative appointment information; a saving element for saving the sorted received representative appointment information; and an interactive element for allowing access to the displayed received representative appointment information.

The accompanying drawings, which are incorporated in and constitute a part of this specification, together with the description, serve to further explain the principles of the invention.

### BRIEF DESCRIPTION OF THE DRAWINGS

The present invention can be understood more completely by reading the following Detailed Description of exemplary embodiments, in conjunction with the accompanying drawings, in which:

FIG. 1 is a simplified schematic representation illustrating one example of a computer network configuration for use with one embodiment of the present invention;

FIG. 2 is a flowchart illustrating the steps in a preferred method for providing access to appointment information;

FIG. 3 is a preferred embodiment of one example of a proposed interactive display for providing interactive display for providing interactive access to appointment information;

FIG. 4 is a preferred embodiment of a proposed representative appointment information data screen for providing interactive access to current appointment information;

FIG. 5 is a preferred embodiment of a proposed representative appointment information data screen for providing interactive access to pending appointments and information;

FIG. 6 is a preferred embodiment of a proposed representative appointment information data screen for providing interactive access to appointment information modified within a user provided date range;

FIG. 7 is a preferred embodiment of a proposed data screen for presenting and updating contact information for selected representatives.

### DETAILED DESCRIPTION OF THE INVENTION

Reference will now be made in detail to the present preferred embodiment of the invention, an example of which is illustrated in the accompanying drawings in which like reference characters refer to corresponding elements.

The system, method, and software application of the present invention described below, are preferably implemented by an interactive computer software application incorporated within a computer-readable medium such as a hard disk drive, an optical medium such as a compact disk, or the like. Further, the computer-readable medium may be available to a user either locally on the user's computer or remotely over a computer network, such as a local area network (LAN) or through the Internet. The inventive computer software application is designed to receive representative appointment information. The software application then analyzes the representative appointment information and stores it in a convenient, easily accessible and useful manner. Once stored, access to the representative appointment information is preferably provided through an interactive display such through an Internet or an intranet web page.

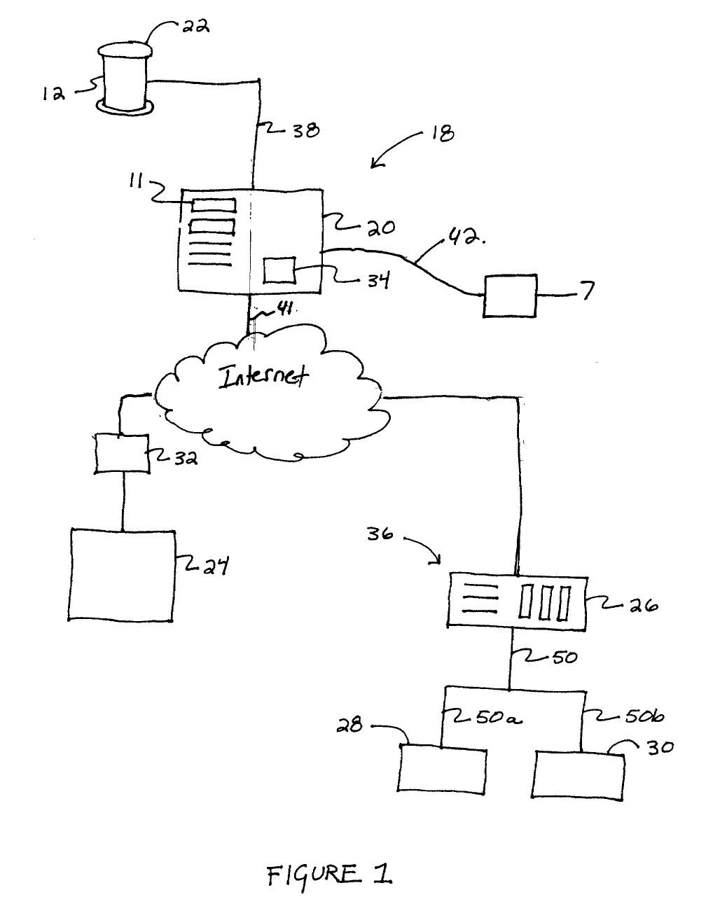

FIG. 1 illustrates an example network arrangement 18 employing the method and system of the present invention in accordance with a preferred embodiment. It should be understood that the present invention operates independent of any particular arrangement or mix of network components and that the network arrangement 18 depicted in FIG. 1 is purely illustrative and simplified for the purpose of explanation.

As shown in FIG. 1, the example network arrangement 18 comprises an application server 20, a database server 22, a network terminal 7, and a plurality of remote terminals 24, 28, and 30. The application server 20 may be any network, Internet, or enterprise server capable of hosting or supporting Internet and/or network access. According to a preferred embodiment, the application server 20 is run using software such as a Netscape Enterprise Server 3.6.2™ application and a Sun Solaris 2.6™ application. Alternatively, any network operating system and server software may be used. For instance, the present invention may use programs and operating system applications such as, for example, a Windows 95™ operating system application, a Windows 98™ operating system application, a Windows 2000™ operating system application, a Windows NT™ operating system application, a MacIntosh™ operating system application, a Unix™ operating system application, an OS/2™ operating system application, and a NetWare™ operating system application.

As shown, the application server 20 includes a processor module 34 and a memory module 11. The database server 22 includes a database program 12. According to a preferred embodiment, the database server 22 and the database program 12 are preferably run using OracleTM compatible programs. Within the scope of the present invention, however, the database server 22 may comprise any software that allows for the management of data structured as fields or records, and that is managed by a database management system (DBMS) such as relational databases produced by, for example, Java™, Sybase™, Microsoft™ and Informix™.

The application server 20 may gain access to the database server 22 via a link 38 and access to a network terminal 7 via a network link 42. Additionally, the application server 20, using an Internet connection 40, may communicate with the remote terminal 24 via a connection device 32 and with the remote terminals 28 and 30 via a network server 26 of a LAN network 36. In accordance with the present invention, the connection device 32 may be any device for connecting remote computers or terminals to other computing devices or networks. For instance, the connection device 32 may be a wireless modem, a cable modem or a DSL modem or other means. The network server 26 connects and communicates with the remote terminals 28 and 30 via a link 50 and a link 50a and a link 50b, respectively.

Within the example network arrangement 18, it is preferable that links to databases are made using an interface such as a Java DataBase Connectivity (JDBC) interface. Alternatively, links to databases, as well as links to other network components, may be comprised of a variety of interfaces and protocols such as, for example: an Open DataBase Connectivity (ODBC) interface; a Network File System (NFS) interface; Web NFS interface; a Server Message Block (SMB) interface; a Samba interface; a Netware Core Protocol (NCP) interface; a Distributed File System (DFS) interface, or Common Internet File System (CIFS) architecture, as well as use such transport protocols as, for example, a TCP/IP protocol, an IPX/SPX protocol, an HTTP protocol, and a NetBEUI protocol.

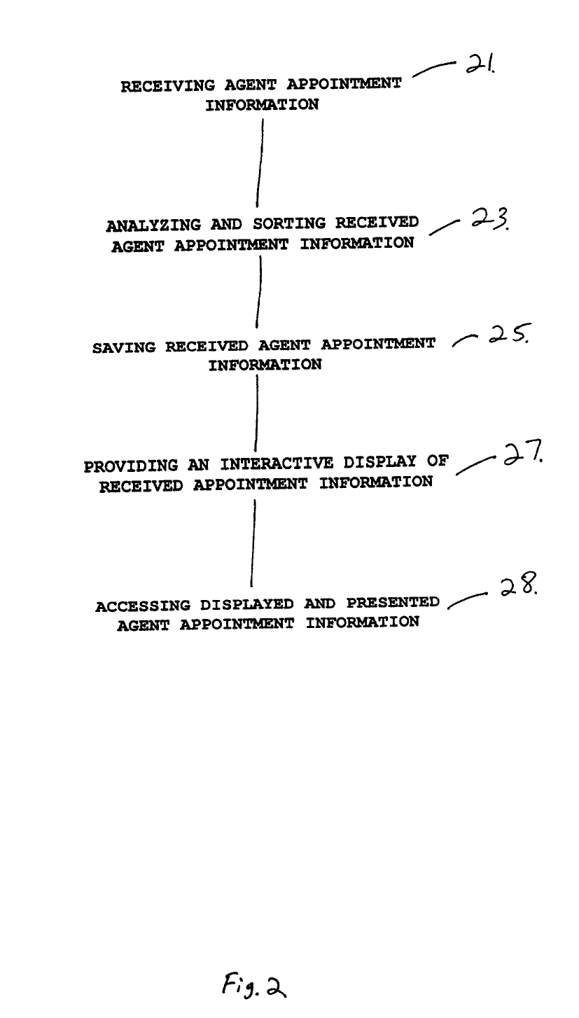

Referring to FIG. 2, there is shown a flow chart illustrating the steps conducted in a method for storing and accessing representative appointment information in accordance with one embodiment of the present invention. In step 21, the representative appointment information is received for analysis and storage. The representative appointment information may be submitted via paper or electronic correspondence or may be submitted using other means such as telephonic means. In accordance with a preferred embodiment, and with reference to FIG. 1, the representative appointment information may initially be entered into network terminal 7 and then transmitted via network link 42 to application server 20. In step 23, the received representative appointment information is analyzed and sorted within the application server 20. Preferably, the analysis and storage of the representative appointment information is accomplished through the use of a database program.

After the representative appointment information is analyzed and sorted, the received and processed representative appointment information, in step 25, is then saved within a selected database. In accordance with a preferred embodiment, and with reference to FIG. 1, the representative appointment information is preferably transmitted via a link 38 to the database server 22 where the information is stored. In step 27, interactive access to the representative appointment information is provided. In accordance with a preferred embodiment of the present invention, the interactive access to the stored representative appointment information is provided via web pages which are stored or “hosted” on the application server 20. In step 28, the representative appointment information is accessed. With reference to FIG. 1, the representative appointment information may be accessed by the remote terminals 24, 28, and 30. In a preferred embodiment, the web page functionality of the present invention is preferably provided using HTML (Hyper Text Markup Language) links with Java Servlets operating to generate reports and presentations for users. Alternatively, any suitable programming or presentation language is within the scope of the present invention. For instance, the present invention may be written in other languages or formats such as Java, JavaScript, SGML, XML, or URML.

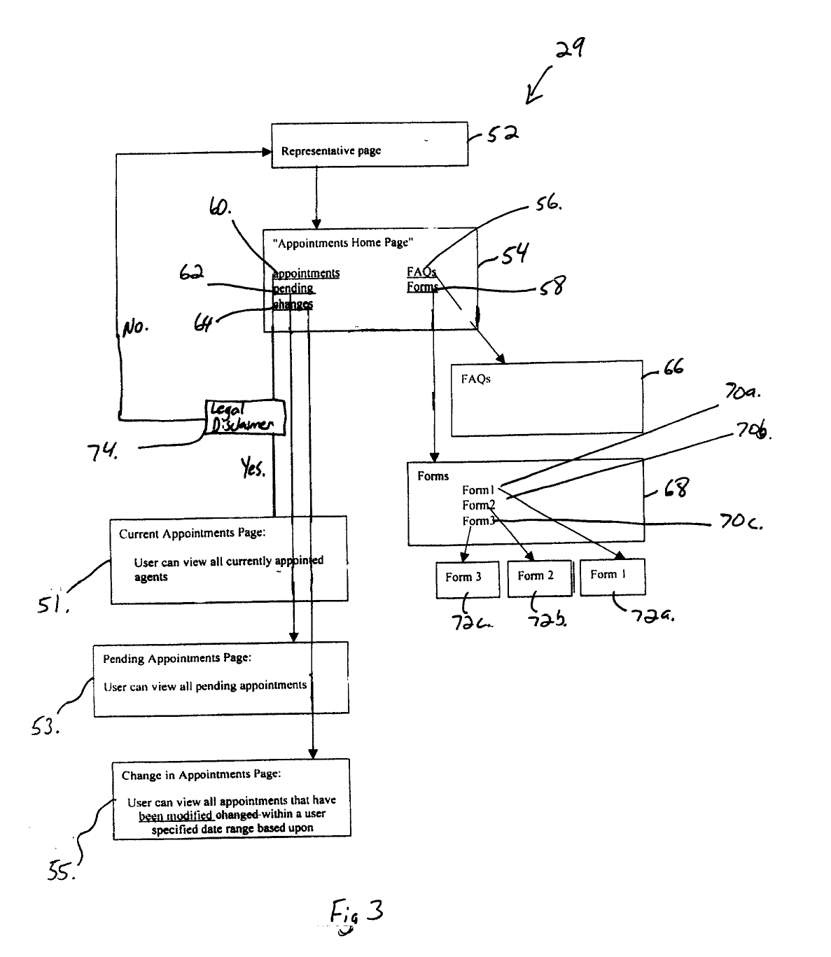

Referring now to FIG. 3, in accordance with a preferred embodiment of the present invention, an interactive display 29 in accordance with step 27 is shown. As shown, users accessing representative appointment information may be first greeted by a greeting screen 52. The greeting screen 52 may incorporate a company logo, announcements, and other such information. Through the greeting screen 52, users may access the representative appointments home page 54 which users may use to access all available representative appointment information by activating embedded links. Accordingly, when users wish to access information regarding current appointments, they may activate the current appointment link 60 to navigate to the current appointments page 51. Similarly, when users wish to access information on pending representative appointments, they may activate the appropriate pending representative appointments link 62 to navigate to a pending appointments page 53. Likewise, when users wish to access information on changes to representative appointments, they may activate a link 64 to navigate to a modified representative appointments page 55. Where desired, navigation to selected pages may be routed through a pop-up screen 74 containing a legal disclaimer which may be accepted or declined. As shown, when the user is unwilling to accept the legal disclaimer, the user is navigated back to the greeting screen 52.

In accordance with a preferred embodiment of the present invention, additional functionality may be built into the representative appointments home page 54. For instance, as illustrated, a link 56 may be provided to navigate users to pages or files containing information such as a frequently asked questions directory 66 or the like. Additionally, as shown, the appointments home page 54 may also include a forms link 58 on which a user may click to navigate to a forms directory 68 containing relevant files. This forms directory 68 may in turn contain links 70a, 70b, 70c to access useful forms 72a, 72b and 72c, respectively.

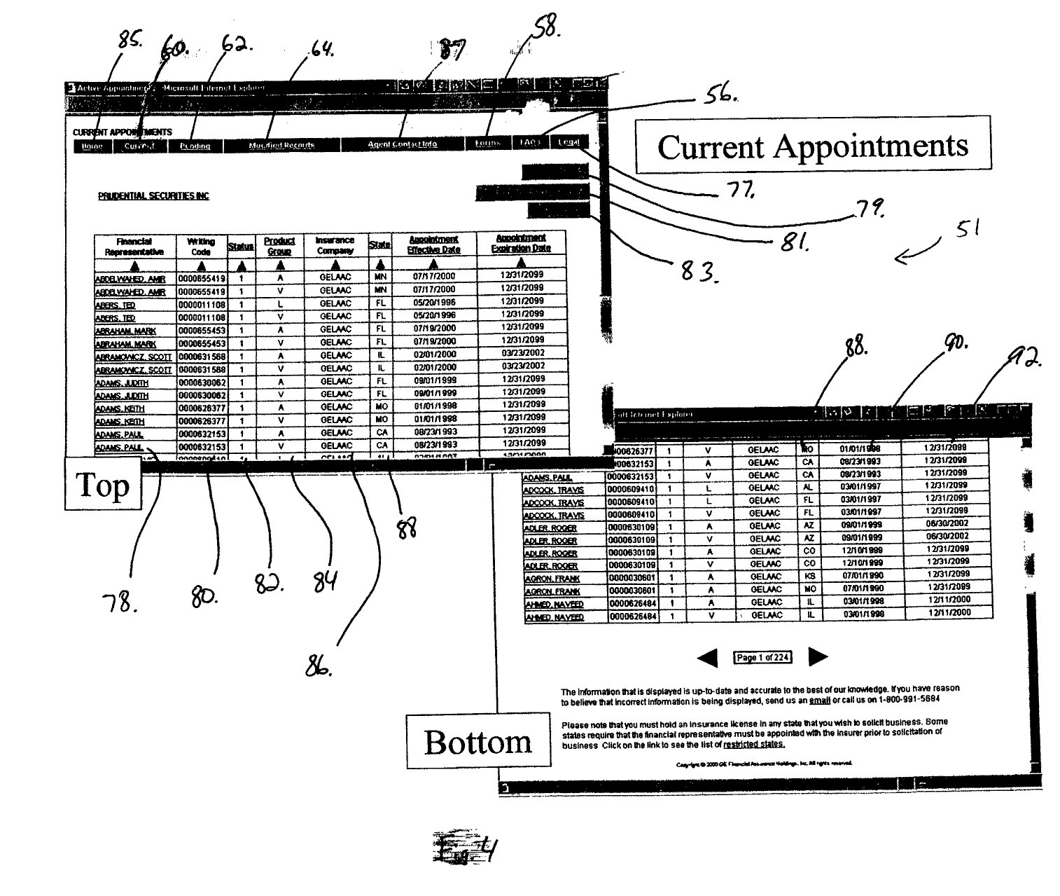

Referring now to FIGS. 4-7, the example information pages 51, 53, 55 and 57 are shown. For each page, exemplary links are provided to assist users in navigating between pages. In accordance with a preferred embodiment, a plurality of links 85, 60, 62, and 64 are provided which link users to the representative appointments home page 54, current representative appointments page 51, pending representative appointments page 53, and to the modified records page 55, respectively. Additionally, each page may contain a plurality of exemplary links 87, 58, 56 and 77 which are preferably used to link users to the contact information page 57, the forms directory 68, the frequently asked questions directory 66, and to a legal disclaimer information page 74, respectively. Users may also be provided access to the contact information page 57 via a link embedded in the name of each selected representative which navigates the user to the contact information page 57 when activated.

Further, in accordance with a preferred embodiment, each page may contain a plurality of Graphical User Interface (GUI) icons and buttons which allow for specialized functionality within each page. In the example pages shown, each page is provided with a contact button 79 to generate an e-mail message or the like for an appointment administrator. Additionally, as shown, a sort button 81 is provided to allow users to arrange the order of the information provided. Further, a download button 83 is provided to allow users to download and electronically retrieve selected information.

With reference to FIG. 4, the current representative appointments page 51 is shown. Within the current representative appointments page 51, a plurality of data fields for displaying selected financial representative information are provided. Among the exemplary fields provided are: a representative field 78 which lists a name of a representative; a writing code field 80; a status field 82, indicating a status of the representative; and a product field 84, indicating which products the financial representative may sell. With respect to the status field 82, in accordance with a preferred embodiment, a status code of 1 or 2 may indicate that the appointment of the representative is current, and status code of 3, 4, or 5 may indicate that the appointment is pending and consequently not in force. Additional exemplary fields may include: a company field 86, indicating a company with which the representative is appointed; a state field 88, indicating a state where the representative is authorized to solicit applications for insurance; an appointment date field 90, which displays the effective appointment date for the representative; and an appointment expiration field 92, which displays the expiration date of the representative's appointment.

For selected fields, “pop-up” boxes and “pull-down” menus may be provided to assist users in entering information correctly. For instance, in accordance with a preferred embodiment, the status field 82 may contain a pulldown menu which provides definitions for each status code; the product field 84 may contain a pull-down menu containing definitions of product group codes; the state field 88 may contain a pop-up box displaying restricted and unrestricted states; the appointment date field 90 may contain a pop-up box containing a definition of “Appointment Effective Date”; and the appointment expiration field 92 may contain a pop-up box displaying the definition of “Appointment Effective Date.”

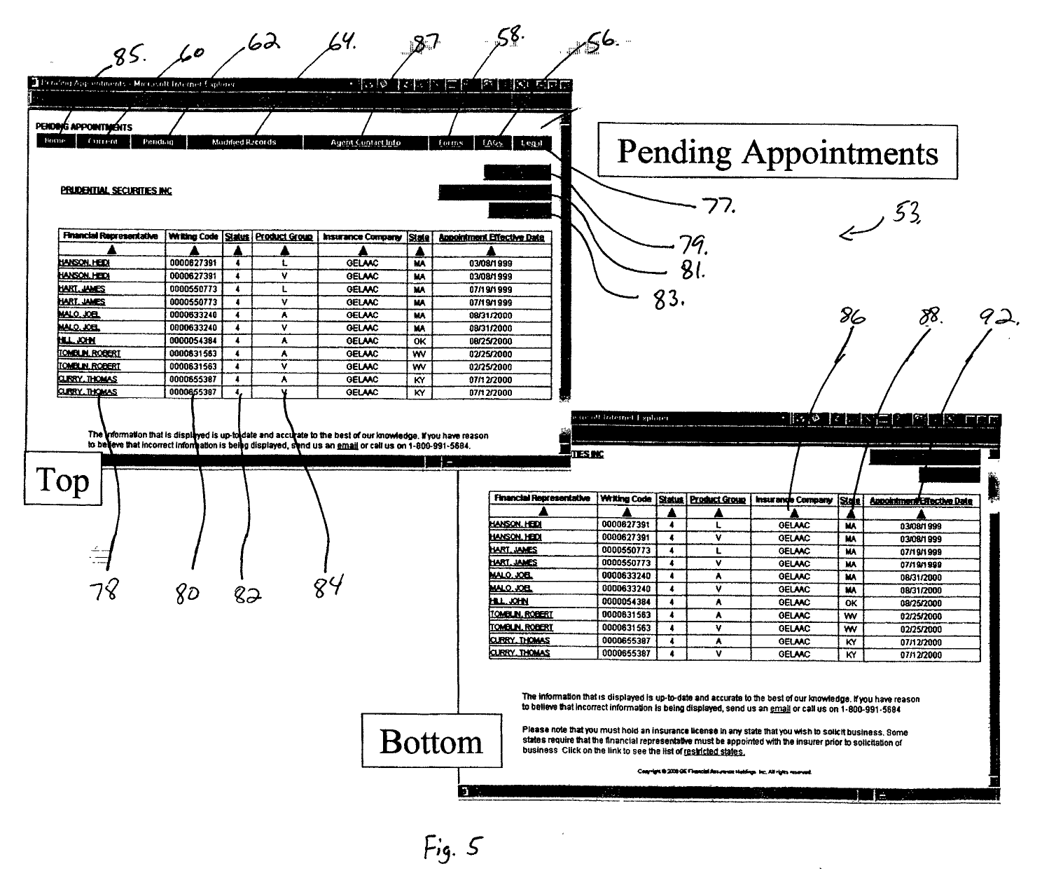

Referring now to FIG. 5, an example pending appointments page 53 is shown. Within the pending appointments page 53, a plurality of data fields for displaying selected representative information related to pending appointments are provided. These fields include: a representative field 78 which lists a name of a representative; a writing code field 80; a status field 82, indicating a status of the representative; and a product field 84, indicating which products the financial representative may sell. Additional fields, as shown, include: a company field 86, indicating a company with which the representative is appointed; a state field 88, indicating a state where the representative is authorized to solicit applications for insurance; and an appointment date field 90, which displays an expected effective appointment date for each representative.

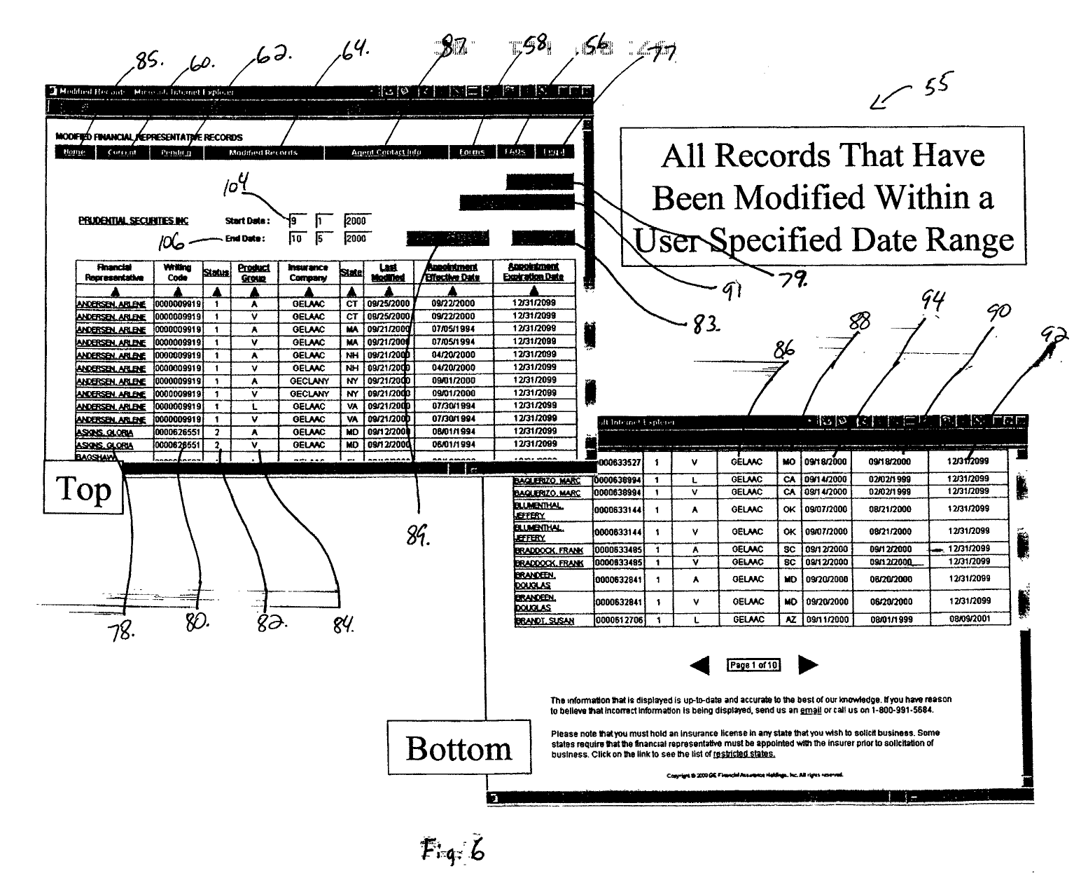

Reference now to FIG. 6, modified appointments page 55 is shown. Within modified appointments page 55, data fields for displaying selected representative information are provided. These fields include: a representative field 78 which lists a name of a representative; a writing code field 80; a status field 82, indicating a status of the representative; and a product field 84, indicating which products the financial representative may sell. Additional exemplary fields, as shown, may include: a company field 86, indicating a company with which the representative is appointed; a state field 88, indicating a state where the representative is authorized to solicit applications for insurance; an appointment date field 90, which displays an effective appointment date for each representative; and an appointment expiration field 92, which displays an expiration date of each representative's appointment.

Additionally, the modified appointments page 55, provides additional fields which allow users to search for all records that have been modified within a specific user specified date range. To allow for this functionality, the modified appointments page 55 provides a start date field 104 and end date field 106 for users to complete and submit using the submit query icon 89.

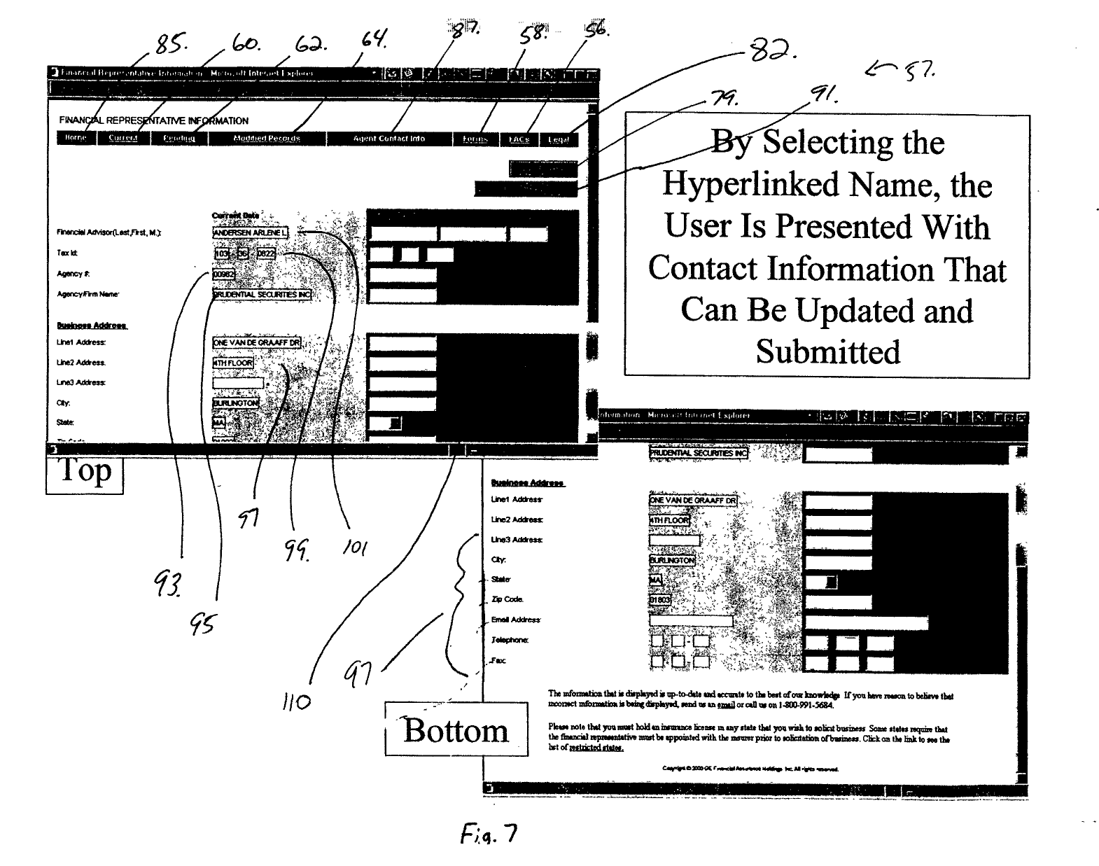

With reference now to FIG. 7, an example contact information page 57 is shown. As illustrated in FIG. 7, the information contained in this page may include: the financial representative's name 101, the financial representative's tax ID number 99, the financial representative's agency number 93 as well as the financial representative's agency or firm name 95. Additionally, business address information 97 may also be provided. As further provided, desired changes may be made to each of the data fields provided in the contact information page 57 by making changes within the desired changes data fields 110 and submitting changes via the submit change button 91.

As is readily apparent from the above detailed description, the system and method of the present invention may be used in a variety of network configurations. The system and method of the invention are also highly flexible and can be easily modified and customized to fit specific situations. For instance, for each of the example web pages discussed, many different fields may be created and used to display pertinent financial representative information as desired. Further, the data fields provided as illustrated in FIG. 4-7 may be deleted and removed altogether. Additionally, present invention may be used within network arrangements such as a local area network (LAN) including an Ethernet and a Token Ring access method, a metropolitan area network (MAN), and a wide area network (WAN). Further, although the preferred embodiments are discussed with reference to the Windows NTTM environment, the present invention may also be used in a variety of other server platforms and operating environments such as, for example, Windows 95, 98 and 2000, Unix, OS/2 and NetWare.

Additionally, the present invention may be used to test a variety of networking links including those based upon, for example, a Network File System (NFS); a Web NFS; a Server Message Block (SMB); a Samba; a Netware Core Protocol (NCP); a Distributed File System (DFS), and a Common Internet File System (CIFS) architecture, as well as use such transport protocols as, for example, TCP/IP, IPX/SPX, HTTP and NetBEUI.

The invention has been described with particular reference to preferred embodiments which are intended to be illustrative rather than restrictive. Alternative embodiments will become apparent to those skilled in the art to which this invention pertains without departing from its spirit and scope. Thus, such variations and modifications of the present invention can be effected within the spirit and scope of the following claims.

What is claimed is:

1. A method for enabling interactive access to and verification of representative appointment information, said method comprising the steps of:
providing one or more instructions for receiving the representative appointment information;
providing one or more instructions for analyzing and sorting the received representative appointment information;
providing one or more instructions for saving the received representative appointment information;
providing one or more instructions for presenting an interactive display of the received representative appointment information; and
providing an interface means to allow access to the displayed and presented received representative appointment information.

2. The method of claim 1, wherein said interactive access is provided via the Internet.

3. The method of claim 2, wherein said representative appointment information comprises:
a plurality of current representative appointment information; and
a plurality of pending representative appointment information.

4. The method of claim 3, wherein said method further comprises the steps of:
providing one or more instructions for inputting a date range; and
providing one or more instructions for displaying the representative appointment information modified within said inputted date range.

5. The method of claim 4, wherein said method further comprises the steps of:
providing one or more instructions for allowing the submission of updates to the representative appointment information; and
providing one or more instructions for accepting and processing submitted updates to the representative appointment information.

6. The method of claim 3, wherein said plurality of current representative appointment information comprises:
a plurality of representative identification fields; and
a plurality of representative authorization fields.

7. The method of claim 6, wherein said plurality of representative identification fields comprises:
a writing code field;
a representative status field;
an appointment effective date field; and
an appointment expiration date field.

8. The method of claim 6, wherein said plurality of representative authorization fields comprises:
a product group field;
a company field; and
a state field.

9. The method of claim 3, wherein said plurality of pending representative appointment information comprises:
a plurality of representative identification fields; and
a plurality of representative authorization fields.

10. The method of claim 9, wherein said plurality of representative identification fields comprises:
a writing code field;
a representative status field; and
an appointment effective date field.

11. The method of claim 9, wherein said plurality of representative authorization fields comprises:
a product group field;
a company field; and
a state field.

12. A computer readable medium including a software application for enabling interactive access to representative appointment information, said software application comprising:
one or more instructions for receiving the representative appointment information;
one or more instructions for analyzing and sorting the received appointment information;
one or more instructions for saving the received representative appointment information;
one or more instructions for presenting an interactive display of the received representative appointment information; and
an interface means for allowing interactive access to the displayed and presented received representative appointment information.

13. The software application of claim 12, wherein said interactive access is provided via the Internet.

14. The software application of claim 13, wherein said representative appointment information comprises:
a plurality of current representative appointment information; and
a plurality of pending representative appointment information.

15. The software application of claim 14, wherein said software application further comprises:
one or more instructions for inputting a date range; and
one or more instructions for displaying the representative appointment information modified within said inputted date range.

16. The software application of claim 15, wherein said software application further comprises:
one or more instructions for allowing the submission of updates to the representative appointment information; and
one or more instructions for accepting and processing submitted updates to the representative appointment information.

17. The software application of claim 14, wherein said plurality of current representative appointment information comprises:
a plurality of representative identification fields; and
a plurality of representative authorization fields.

18. The software application of claim 17, wherein said plurality of representative identification fields comprises:
a writing code field;
a representative status field;
an appointment effective date field; and
an appointment expiration date field.

19. The software application of claim 17, wherein said plurality of representative authorization fields comprises:
a product group field;
a company field; and
a state field.

20. The software application of claim 14, wherein said plurality of pending representative appointment information comprises:
a plurality of representative identification fields; and
a plurality of representative authorization fields.

21. The software application of claim 20, wherein said plurality of representative identification fields comprises:
a writing code field;
a representative status field; and
an appointment effective date field.

22. The software application of claim 20, wherein said plurality of representative authorization fields comprises:
a product group field;
a company field; and
a state field.

23. A server system for providing access to representative appointment information, said system comprising:
an inputting element for inputting received representative appointment information;
a processing element for analyzing and sorting the received representative appointment information;
a saving element for saving the received representative appointment information;
an interactive element for allowing an interactive display of the received representative appointment information;
an interface element for allowing access to the displayed received representative appointment information.

24. The system of claim 23, wherein said access is provided via the Internet.

25. The system of claim 24, wherein said representative appointment information comprises:
a plurality of current representative appointment information; and
a plurality of pending representative appointment information.

26. The system of claim 25, wherein said system further comprises:
one or more instructions for inputting a date range; and
one or more instructions for displaying appointment information modified within said inputted date range.

27. The system of claim 26, wherein system further comprises:
one or more instructions for allowing submission of updates to the representative appointment information; and
one or more instructions for accepting and processing the submitted updates to the representative appointment information.

28. The method of claim 25, wherein said plurality of current representative appointment information comprises:
a plurality of representative identification fields; and
a plurality of representative authorization fields.

29. The method of claim 28, wherein said plurality of representative identification fields comprises:
a writing code field;
a representative status field;
an appointment effective date field; and
an appointment expiration date field.

30. The method of claim 28, wherein said plurality of representative authorization fields comprises:
a product group field;
a company field; and
a state field.

31. The method of claim 25, wherein said plurality of pending representative appointment information comprises:
a plurality of representative identification fields; and
a plurality of representative authorization fields.

32. The method of claim 31, wherein said plurality of representative identification fields comprises:
a writing code field;
a representative status field; and
an appointment effective date field.

33. The method of claim 31, wherein said plurality of representative authorization fields comprises:
a product group field;
a company field; and
a state field.
